(19) United States
(12) Patent Application Publication
(10) Pub. No.: US 2016/0341990 A1
(43) Pub. Date: Nov. 24, 2016

(54) A BACKLIGHT MODULE AND SPRAYING JIG

(71) Applicant: SHENZHEN CHINA STAR OPTOELECTRONICS TECHNOLOGY CO., LTD., Shenzhen, Guangdong (CN)

(72) Inventor: Yanxue ZHANG, Shenzhen (CN)

(21) Appl. No.: 14/425,850

(22) PCT Filed: Nov. 26, 2014
(86) PCT No.: PCT/CN2014/092308

§ 371 Date: Mar. 4, 2015

(30) Foreign Application Priority Data
Nov. 7, 2014 (CN) 201410626095.8

(51) Int. Cl. G02F 1/1335; B05B 13/06; F21V 11/16

(52) U.S. Cl. CPC G02F 1/1336; G02F 1/133512; F21V 11/16; B05B 13/06; G02F 2202/28

(57) ABSTRACT

A backlight module includes a backlight assembly for generating a backlight source, and the upper surface of the backlight assembly is an optical film, and a light shading layer is spayed around the upper surface of the optical film. Though spraying the light shading layer around the optical film, the backlight module of the present invention finely solves the defects of the prior art, i.e., the process for mechanically cutting the black double-faced adhesive tape is complicate, and the narrow bezel display can hardly be achieved, meanwhile, it increases the optical taste of the display products.

### CROSS REFERENCE TO RELATED PATENT APPLICATIONS

This application claims the benefit under 35 U.S.C. Section 371, of PCT International Application No. PCT/CN2014/092308, filed Nov. 26, 2014, which claimed priority to Chinese Patent Application No. 201410626095.8, filed Nov. 7, 2014, the disclosures of which are hereby incorporated by the references.

### BACKGROUND OF THE INVENTION

1. Field of the Invention

The present invention relates to the technical field of display, in particular, to a backlight module and spraying jig.

2. The Related Arts

With the development of small-to-medium-size electronics technology, the narrow bezel backlight design becomes an important technology affecting the module bezel design. In the conventional product design, it is usual to paste the black double-faced adhesive tape on the surface of the backlight source so as to fix the display panel. Since the black double-faced adhesive tape is a colloid with base material, it needs to be mechanically cut, and it will be artificially or mechanically attached after the cutting, such that the width of the double-faced adhesive tape cannot be too slim to be cut or attached, thereby affecting the bezel size of the display product.

### SUMMARY

In view of the disadvantages present in the related art, the present invention provides a backlight module that has a simple structure and is capable of achieving a narrow bezel design.

In order to achieve the above object, the present invention adopts the following technical solutions:

A backlight module, comprising a backlight assembly for generating a backlight source, and the upper surface of the backlight assembly is an optical film, and a light shading layer is spayed around the upper surface of the optical film.

Wherein the upper surface of the optical film further comprises a transparent double-faced pasting layer disposed adjacent to the inner side of the light shading layer.

Wherein the double-faced pasting layer is OCA (Optically Clear Adhesive).

Or the double-faced pasting layer is OCR (Optical Clear Resin).

Wherein the light shading layer is dye.

The present invention also provides a spraying jig for spraying the light shading layer of the backlight module described as above, and comprising a rectangular first shading plate and a rectangular second shading plate, wherein the second shading plate is a frame structure, and the first shading plate is disposed in the second shading plate, and the first shading plate and the second shading plate are connected by connecting strips so as to form an interval groove therebetween, thereby performing a spraying through the interval groove.

Wherein the connecting strips are in plural to space the interval groove into a plurality of isolated regions.

Wherein the first shading plate is disposed with a hollow groove at the center portion thereof.

Due to the light shading layer sprayed around the optical film of the backlight module of the present invention, it finely solves the defects of the prior art, i.e., the process for mechanically cutting the black double-faced adhesive tape is complicate, and the narrow bezel display can hardly be achieved, meanwhile, it increases the optical taste of the display products.

### BRIEF DESCRIPTION OF DRAWINGS

FIG. 1 is a plan view of a backlight module of the first embodiment of the present invention.

FIG. 2 is a side view of a backlight module of the first embodiment of the present invention.

FIG. 3 is a schematic view of the structure of a spraying jig of a backlight module of the second embodiment of the present invention.

### DETAILED DESCRIPTION

In order to make the object, the technical solution and advantages of the present invention more apparent and clear, hereinafter, the present invention will be further described in detail in conjunction with accompanying drawings and embodiments. It is understood that the specific embodiments described herein are used only to explain the present invention without being used to limit the present invention.

### Embodiment 1

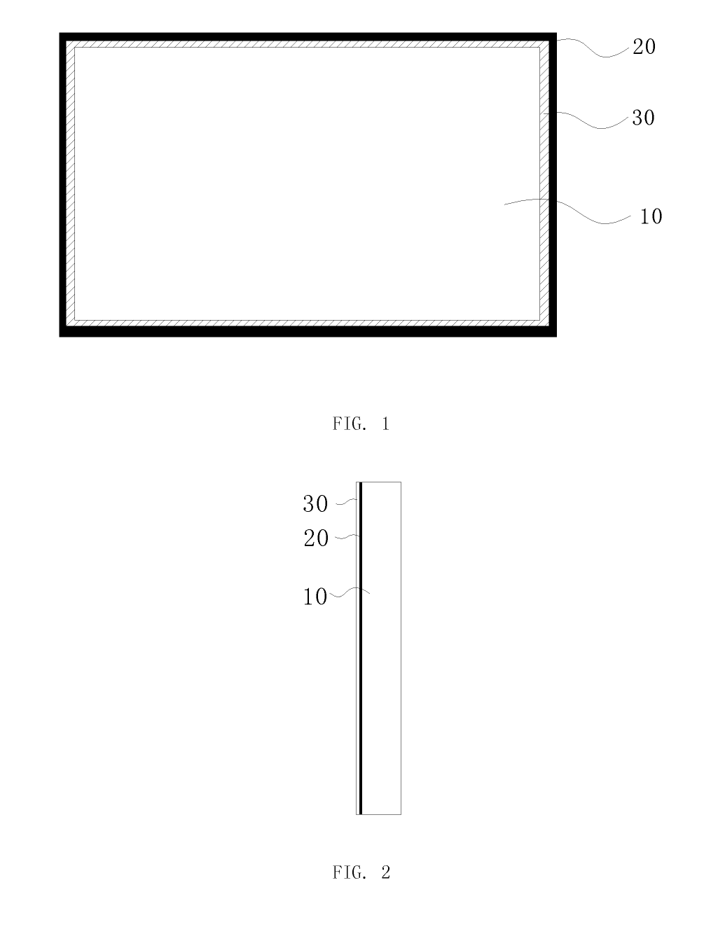

Referring to FIG. 1 and FIG. 2, the present invention provides a backlight module, which comprises a backlight assembly 10 for generating a backlight source, and the upper surface of the backlight assembly 10 is an optical film, and a light shading layer 20 is spayed around the upper surface of the optical film.

The light shading layer 20 is formed around the uppermost layer of the optical film of the backlight assembly 10, for absorbing the surplus light generated around the backlight assembly 10, and eliminating the light pollution while avoiding the generation of highlight areas.

In order to paste the liquid crystal panel on the backlight assembly 10, the upper surface of the optical film is provided with a transparent double-faced pasting layer 30 adjacent to the inner side of the light shading layer 20. Further, the double-faced pasting layer 30 is OCA (Optically Clear Adhesive, a solid transparent optical adhesion) or OCR (Optically Clear Resin, a liquid transparent optical adhesion). In consideration of the compressibility of the double-faced pasting layer 30, the thickness of the double-faced pasting layer 30 in the embodiment is slightly greater than that of the light shading layer 20, and when the liquid crystal panel is pasted to the backlight assembly 10, the height of the double-faced pasting layer 30 is the same as that of the light shading layer 20. It can be understood that, the thickness of the double-faced pasting layer 30 may also be the same as that of the light shading layer 20.

In particular, in order to achieve the effect of light shading and absorbing, the light shading layer 20 is the black dye or ink, etc.

### Embodiment 2

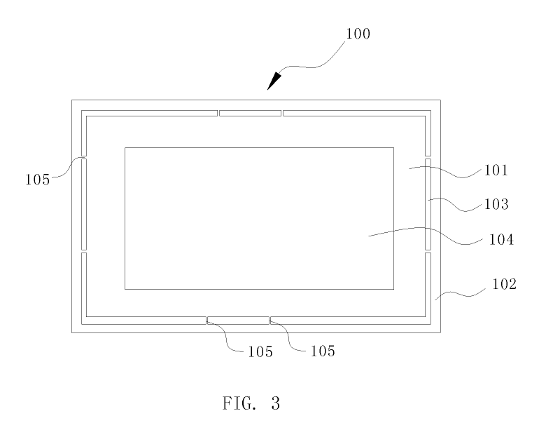

As shown in FIG. 3, in order to increase the spraying accuracy and efficiency of the light shading layer 20, the present invention also provides a spraying jig 100, which comprises a rectangular first shading plate 101 and a rectangular second shading plate 102. The second shading plate 102 is a frame structure, and the outline dimension of the second shading plate 102 is greater than that of the backlight assembly 10, and the first shading plate 101 is disposed in the second shading plate 102, and the first shading plate 101 and the second shading plate 102 are connected by a plurality of connecting strips 105 so as to form an interval groove 103 therebetween, thereby performing a spraying through the interval groove 103.

The plurality of connecting strips 105 is disposed in intervals between the first shading plate 101 and the second shading plate 102, for connecting the first and second shading plates 101 and 102 and spacing the interval groove 103 into a plurality of isolated groove regions.

Meanwhile, in order to reduce the manufacturing cost and weight of the spraying jig, the first shading plate 101 is disposed with a hollow groove 104 at the center portion thereof.

When a specific spraying is made, the spraying jig 100 covers the upper surface of the optical film of the backlight assembly 10, and the interval groove 103 is aligned to be sprayed after the spraying position being determined so as to form the light shading layer 20.

Though spraying the light shading layer 20 around the optical film, the backlight module of the present invention finely solves the defects of the prior art, i.e., the process for mechanically cutting the black double-faced adhesive tape is complicate, and the narrow bezel display can hardly be achieved, meanwhile, it avoids light pollution and increases the optical taste of the display products.

What described as above are the specific embodiments of the present application only. It is pointed out that, it can be made various improvements and modifications for those ordinary skilled in the art without departing the principle of the present application, and these improvements and modifications are also considered as the protection scope of the present application.

What is claimed is:

1. A backlight module, comprising a backlight assembly for generating a backlight source, and the upper surface of the backlight assembly being an optical film, and a light shading layer being spayed around the upper surface of the optical film.

2. The backlight module according to claim 1, wherein the upper surface of the optical film further comprises a transparent double-faced pasting layer disposed adjacent to the inner side of the light shading layer.

3. The backlight module according to claim 2, wherein the double-faced pasting layer is OCA.

4. The backlight module according to claim 2, wherein the double-faced pasting layer is OCR.

5. The backlight module according to claim 1, wherein the light shading layer is dye.

6. The backlight module according to claim 2, wherein the light shading layer is dye.

7. The backlight module according to claim 3, wherein the light shading layer is dye.

8. The backlight module according to claim 4, wherein the light shading layer is dye.

9. A spraying jig, for spraying the light shading layer of the backlight module according to claim 1, comprising a rectangular first shading plate and a rectangular second shading plate, wherein the second shading plate is a frame structure, and the first shading plate is disposed in the second shading plate, and the first shading plate and the second shading plate are connected by connecting strips so as to form an interval groove therebetween, thereby performing a spraying through the interval groove.

10. The spraying jig according to claim 9, wherein the connecting strips are in plural to space the interval groove into a plurality of isolated regions.

11. The spraying jig according to claim 9, wherein the first shading plate is disposed with a hollow groove at the center portion thereof.

12. The spraying jig according to claim 10, wherein the first shading plate is disposed with a hollow groove at the center portion thereof.
